(19) United States
(12) Patent Application Publication
(10) Pub. No.: US 2026/0244646 A1
(43) Pub. Date: Aug. 20, 2026

(54) Partial Data Synchronization

(71) Applicant: Oracle International Corporation, Redwood Shores, CA (US)

(72) Inventors: Allen Roshan D’Souza, Houston, TX (US); Dipen Ashvinkumar Joshi, Katy, TX (US); Ankur Handa, Santa Clara, CA (US); Mukesh Tyagi, Aldie, VA (US); Shovan Sutar, Palo Alto, CA (US); Srikanth Reddy Surapu, Bridgewater, NJ (US); Konatham Chandrajith Yadav, Hyderabad (IN); Shashi Kanth Gottipati, Hyderabad (IN); Venkata Narsimha Rao Gurrapu Srinivas, Hyderabad (IN)

(73) Assignee: Oracle International Corporation, Redwood Shores, CA (US)

(21) Appl. No.: 19/338,482

(22) Filed: Sep. 24, 2025

Related U.S. Application Data
(60) Provisional application No. 63/760,360, filed on Feb. 19, 2025.

(51) Int. Cl. G06F 16/27; G06F 16/23

(52) U.S. Cl. CPC G06F 16/275; G06F 16/2308

(57) ABSTRACT

A system that partially synchronizes data items of a computational dataset with updated data items of a reference dataset in response to determining that execution of one or more computational processes is planned is disclosed. The system identifies data items in the computational dataset that are expected to be accessed by the planned computational processes when executed. The system then partially synchronizes the identified data items by updating data items in the computational dataset based on corresponding data items from the reference dataset. Data items in the computational dataset that are not expected to be accessed by the planned computational processes are excluded from synchronization.

### INCORPORATION BY REFERENCE; DISCLAIMER

Each of the following applications are hereby incorporated by reference: application no. 63/760,360 filed on Feb. 19, 2025. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to synchronizing data between data storage locations.

### BACKGROUND

Computer systems synchronize data between multiple storage locations to maintain consistency. When data is changed in one storage location, synchronization propagates the changes across the other storage locations to allow different computing systems to access the same data. For example, a computer may store a backup copy of a primary storage device in a secondary storage device. In response to changes to the data in the primary device, the computer may update the secondary device to ensure the backup reflects the changes.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1A illustrates a functional block diagram of an example data synchronization architecture in accordance with one or more embodiments;

FIG. 1B illustrates a system block diagram of an example data synchronization architecture in accordance with one or more embodiments;

FIGS. 2A and 2B illustrate an example set of operations for partially synchronizing datasets in accordance with one or more embodiments;

FIGS. 3A, 3B, and 3C illustrate example data structures used for partially synchronizing datasets in accordance with one or more embodiments;

FIG. 4 illustrates a system block diagram showing an example embodiment of data synchronization system in accordance with one or more embodiments;

FIG. 5 illustrates a machine learning (ML) engine in accordance with one or more embodiments;

FIG. 6 illustrates the operation of an ML engine in accordance with one or more embodiments; and

FIG. 7 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. PRACTICAL APPLICATIONS, ADVANTAGES & IMPROVEMENTS
3. SYNCHRONIZATION MANAGEMENT ARCHITECTURE
4. PARTIAL SYNCHRONIZATION
5. EXAMPLE PARTIAL SYNCHRONIZATION
6. MACHINE LEARNING ARCHITECTURE
7. HARDWARE OVERVIEW
8. MISCELLANEOUS; EXTENSIONS

### 1. General Overview

A system may store both a reference dataset and a corresponding computational dataset. The reference dataset maintains data items that reflect accurate and/or current values for a set of fields. The computational dataset includes copies of at least a portion of the data items, from the reference dataset, that are accessed by one or more computational processes. In other words, the computational processes access the data items in the computational dataset as a source of information for performing computations. The system may store both the reference dataset and the computational dataset on a same device and/or same type of memory. The system may store the reference dataset and the computational dataset in different failure domains. The system may, for example, duplicate the reference dataset to generate the computational dataset in order to protect the reference dataset from corruption that may result from frequent access by the computational processes. The system may maintain the reference dataset and the computational dataset for redundancy for failover operations due to data corruption, security/access controls, etc. The reference dataset and computational dataset may, for example, be stored in respective regions of the same type of hard drives, the same type of secondary storage systems, or the same type of cloud memory components. The reference dataset and the computational dataset may even be stored in different regions of the same hardware memory component. When data items in the reference dataset are updated, the computational dataset temporarily becomes out-of-sync with the reference dataset because the data items in the computational dataset no longer reflect the current values in the reference dataset.

One or more embodiments partially synchronize/update a computational dataset with a corresponding reference dataset based on the expected use of the data in the computational dataset by computational processes. A partial synchronization process determines planned computational processes and the data items from the computational dataset that are to be used for the planned computation processes. The partial synchronization process then synchronizes the data items of the computational dataset, that are to be used by the computational processes, with corresponding data items of the reference dataset while refraining from updating other data items within the computational dataset.

One or more embodiments initiate an evaluation process for determining whether or not to synchronize data items included in the computational dataset with current data items from the reference dataset subsequent to and in response to detecting a planned execution of one more computational processes. A system detects the scheduling or planning of computational processes. The system then identifies data items in the computational dataset that are to be accessed by the planned computational processes. The system partially synchronizes data items in the computational dataset, that are expected to be accessed by the computational processes, based on corresponding data items in the reference dataset. The partial synchronization refrains from synchronizing other data items in the computational dataset that are not expected to be accessed by the computational process. As a result, the system generates an updated computational dataset that is partially synchronized with the updated reference dataset.

One or more embodiments described in this Specification and/or recited in the claims may not be included in this General Overview section.

### 2. Practical Applications, Advantages & Improvements

Embodiments in accordance with the present disclosure enhance version management of computing systems, such as distributed multi-node and cloud-based architectures, by using a partial synchronization process that refrains from updating data that is not accessed by planned computations. Using partial synchronization, computing systems are able to efficiently scale synchronization processes by avoiding unnecessary consumption of computing resources to update data that will not be used in planned computations. For example, a data item in a reference dataset may be updated multiple times. However, the computational dataset may not be synchronized with the updated computational dataset when the data item is not accessed by any planned computation. Additionally, embodiments avoid processing errors, such as generating faulty commands or outputs, caused by prematurely enforcing consistency among versions of a dataset.

### 3. Synchronization Management Architecture

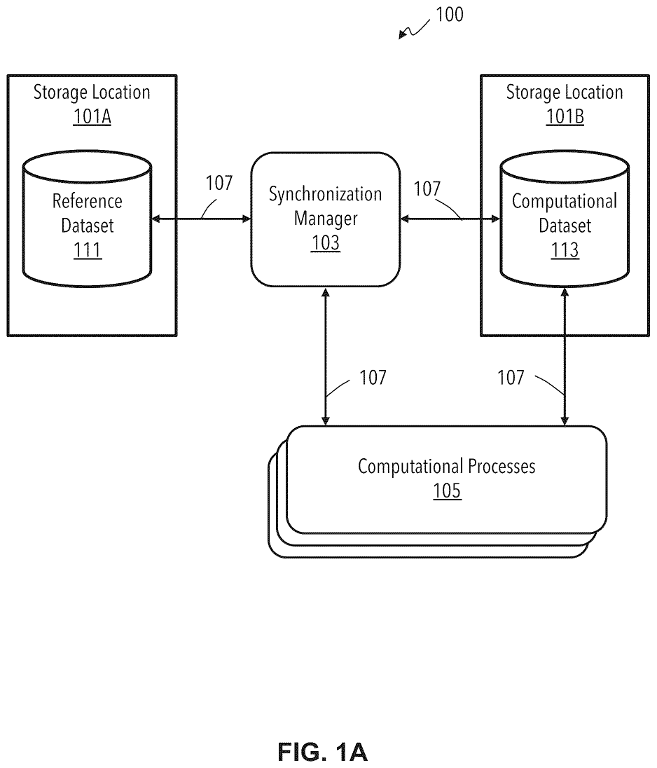

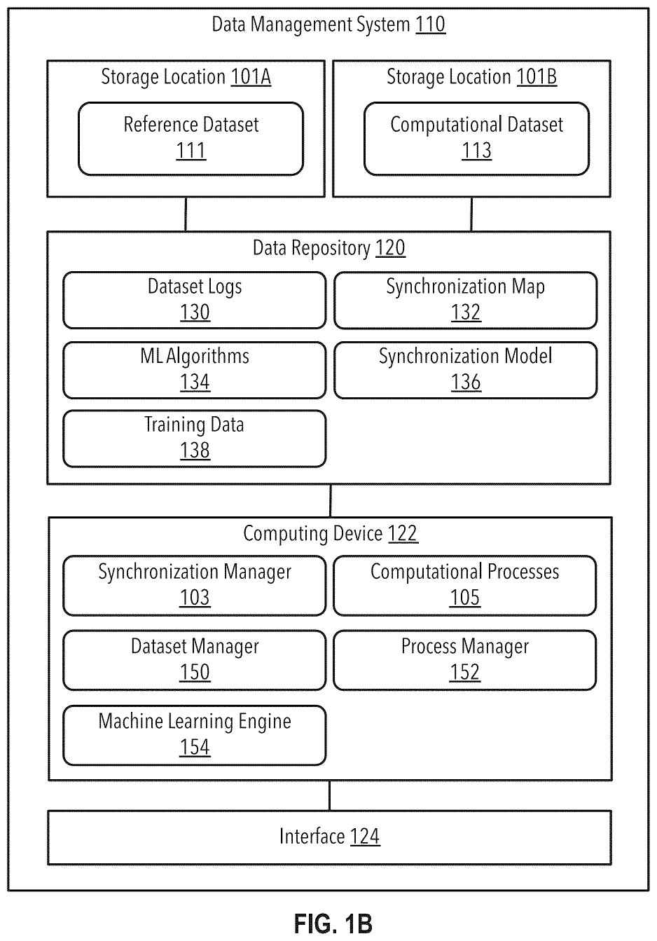

FIG. 1A illustrates an example data synchronization management architecture 100 in accordance with one or more embodiments. As illustrated in FIG. 1A, the architecture 100 includes storage locations 101A and 101B, a synchronization manager 103, and computational processes 105 that are communicatively connected, directly or indirectly, via one or more communication links 107. In one or more embodiments, the architecture 100 may include more or fewer components than the components illustrated in FIG. 1A. The components illustrated in FIG. 1A may be local to or remote from one another. The components illustrated in FIG. 1A may be implemented in software and/or hardware. The individual component may be distributed over multiple applications and/or machines. Multiple components may be combined into one application and/or machine. Operations described with respect to one component may instead be performed by another component.

The storage locations 101A and 101B are computer-readable memories that include any type of storage unit or device (e.g., a file system, database, collection of tables, or any other storage mechanism). For example, the storage locations 101A and 101B can include one or more of a magnetic storage device (e.g., hard disk drives), a solid state drive (SSD), an optical storage device (e.g., compact disk or digital video disk), random access memory (RAM), a read-only memory (ROM), flash memory, an electrically erasable/programmable read-only memory (EEPROM), cache memory, or other computer-readable storage devices. Furthermore, the storage locations 101A and 101B may include multiple different storage units and/or devices. The storage locations 101A and 101B may or may not be of the same type or located at the same physical site. Furthermore, the storage location 101A may be implemented in the same storage unit or device or in the same computing system as storage location 101B, synchronization manager 103, and the computational processes 105. One or more embodiments of the storage location 101A and the storage location 101B including the reference dataset 111 and computational dataset 113, respectively. As described above, the reference dataset 111 maintains current data and is updated based on changes to data items within the reference dataset 111. For example, the computational dataset 113 may be updated by a user device, an enterprise data system, or a data warehouse. The computational dataset 113 includes copies of at least a portion of the data items in the reference dataset.

The communication links 107 include wired and/or wireless information communication channels, such as the Internet, an intranet, an Ethernet network, a wireline network, a wireless network, a mobile communications network, and/or another communication network. For example, the storage locations 101A and 101B may communicate with the synchronization manager 103 and the computational process 105 via the Internet by exchanging data packets through a Wi-Fi or cellular data network connection.

The synchronization manager 103 is computer hardware, software, or a combination thereof that manages partial synchronization of the datasets 111 and 113 between the storage locations 101A and 101B. As detailed below, partial synchronization includes detecting if data items in the reference dataset 111 have been updated, determining if at least one of the computational processes 105 that access the updated data items of the reference dataset 111 is planned for execution, and identifying data items in the computational dataset to be included in a partial synchronization process of the computational dataset 113 based on the updated data items of the reference dataset 11. Additionally, using the identified data items, the synchronization manager 103 partially synchronizes data items of the computational dataset 113 using corresponding data items of the reference dataset 111.

The computational processes 105 are hardware, software, or combinations of hardware and software that execute computations using the computational dataset 113. An individual computational process 105 may correspond to a single operation or task, such as execution of a query or a data transformation function. In other cases, a computational process 105 may encompass multiple operations or tasks, such as applications, workflows, batch jobs or utilities. Some examples used herein describe the computational processes 105 as processing income taxes. It is understood that embodiments are not limited to these examples and that the computational processes 105 may be any computing process that executes computer-readable program instructions using the computational dataset 113.

In a non-limiting example, the synchronization manager 103 detects an update to the reference dataset 111. In response, the synchronization manager 103 determines if any computations 105 are planned that use the computational dataset 113 that corresponds to the updated reference dataset 111. A “planned computation” refers to a computational process 105 that is scheduled, predicted, or otherwise expected to execute within an upcoming time window. The time window is an interval of time that occurs in the immediate future or near future. In some embodiments, the current time window may be a fixed time interval extending from the present, such as the next minute, hour, or day, depending on the frequency of computations. For example, in a system that schedules computations on a daily basis, a current time window may comprise the next 24-hour period. In a system that schedules computations on an hourly basis, a current time window may comprise the next 15 minutes. A planned computation may include computational processes 105 that are explicitly scheduled for execution during the time window, scheduled for execution during the time window contingent on the occurrence of one or more predefined conditions, and/or predicted to execute in the time window based on historical execution patterns. For the planned computations, the synchronization manager 103 determines data items in the computational dataset 113 that are expected to be accessed by one or more of the planned computational processes 105 and/or determines other data items that will not be accessed by any of the planned computational processes 105. The synchronization manager 103 performs a partial synchronization process that, using the data items in the updated reference dataset 111, synchronizes with the corresponding data items in computational dataset 113 to be accessed by the computational processes 105 that perform the planned computations. Additionally, the partial synchronization process refrains from synchronizing the other data items in the computational dataset 113 that are not to be accessed by the computational processes 105.

FIG. 1B is a block diagram illustrating an example data management system 110 in accordance with one or more embodiments. The data management system 110 includes hardware and software that perform processes and functions described herein. In one or more embodiments, the data management system 110 includes more or fewer components than the components illustrated in FIG. 1B. The components illustrated in FIG. 1B can be local to or remote from one another. The components illustrated in FIG. 1B can be implemented in software and/or hardware. Components can be distributed over multiple applications and/or machines. Multiple components can be combined into one application and/or machine. Operations described with respect to one component can instead be performed by another component.

One or more embodiments of the data management system 110 include the storage location 101A and the storage location 101B that include the reference dataset 111 and the computational dataset 113, respectively. Additionally, the data management system 110 includes a data repository 120 and a computing device 122. The data repository 120 includes any type of storage unit and/or device (e.g., a file system, database, collection of tables, or any other storage mechanism) for storing data. Furthermore, the data repository 120 may include multiple different storage units and/or devices. The multiple different storage units and/or devices may or may not be of the same type or located at the same physical site. Furthermore, the data repository 120 can be implemented or executed on the same computing system as the data management system 110. Additionally, or alternatively, the data repository 120 may be implemented or executed on a computing system separate from the data management system 110. The data repository 120 can be communicatively coupled, wired and/or wirelessly, to the data management system 110 via a direct connection or via a network.

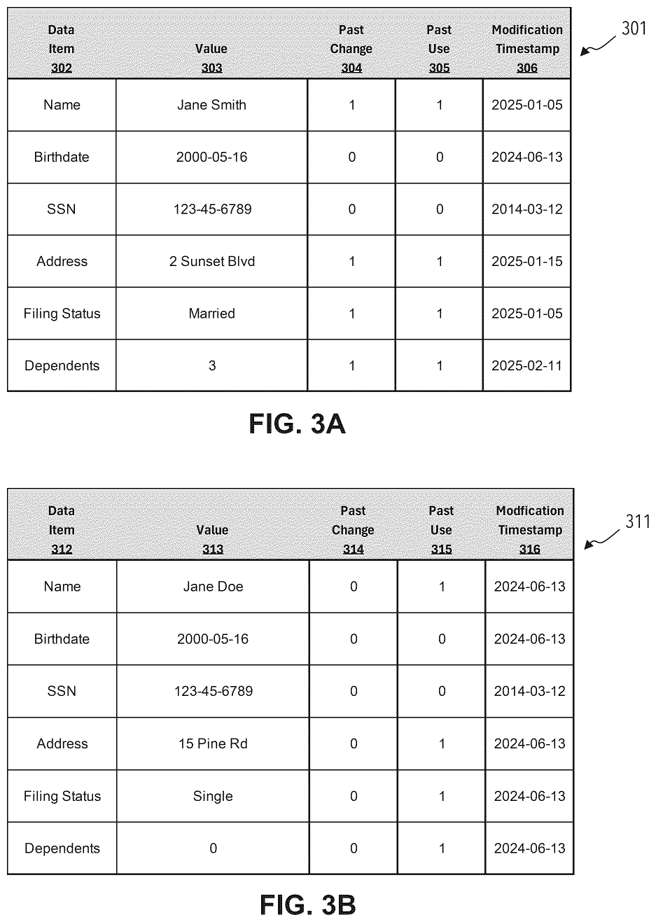

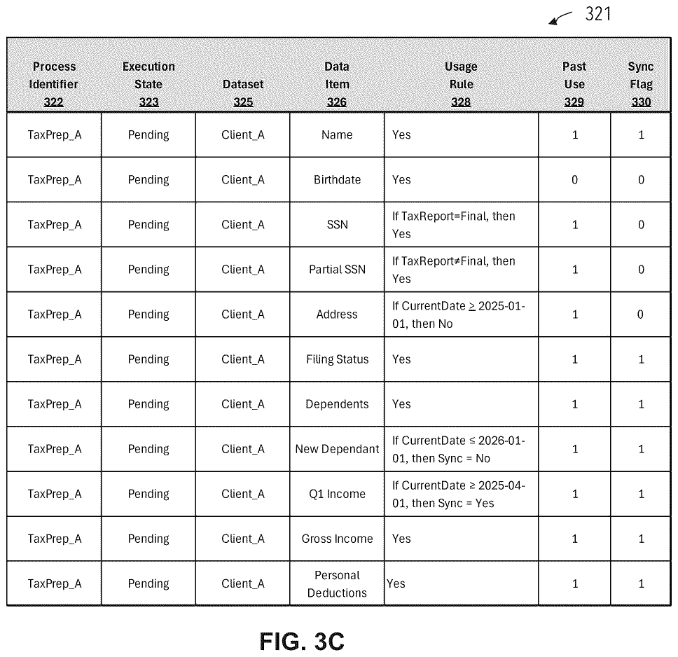

In one or more embodiments, the data repository 120 stores dataset logs 130, a synchronization map 132, machine learning algorithms 134, a synchronization model 136, and training data 138. The dataset logs 130 are one or more data structures that store information associating data items in a dataset, such as reference dataset 111 and computational dataset 113, with metadata describing updates of the data items. As referred to herein, a data item is a discrete unit of information. Example data items include software information objects, such as records, databases, libraries, tables, fields, key-value pairs, or sets of such software objects. Example metadata of a data item includes an identifier of a computational process, timestamps of updates, version identifiers, a count of past updates, a count of past uses of the data items, and checksum values for individual data items. The dataset logs 130 serve as a reference for identifying when a dataset or individual data item in the dataset was last modified to allow tracking and identification of updates for synchronization. The system can determine if any data items in the dataset may be out of date by comparing timestamps between dataset logs 130 stored for the reference dataset 111 and the computational dataset 113. For example, FIG. 3A illustrates a data structure 301 for an example data log of the reference dataset 111 that associates data items 302 with respective update timestamps 306. FIG. 3B illustrates a data structure 311 for an example data log that associates data items 312 of the corresponding computational dataset 113 with respective update timestamps 316. Differences between the timestamps 306 and 316 in the data logs 130 indicate if one or more of the data items in the computational dataset 113 is out of sync in relation to the corresponding data items of the reference dataset 111.

The synchronization map 132 is one or more data structures including information for synchronizing data items of corresponding datasets, such as the datasets 111 and 113. For example, FIG. 3C illustrates a data structure 321 storing an example synchronization map mapping identifiers of a computational process 322 (e.g., “TaxPrepA”) with respective execution states 323, a datasets identifiers 325 (e.g., “Client_A”) corresponding to individual data items 326 in the datasets 325 (e.g., “Name,” “Birthdate,” etc.). The synchronization map 132 also includes usage rules 328, past use parameters 329, and synchronization flags 330. An identifier of a computational process refers to a unique label that distinguishes one computational process from another. The identifier may include a process name or alphanumeric string. For example, individual computational processes may have a globally unique identifier (GUID) assigned by the runtime scheduler or operating system.

The execution state refers to the current or planned execution of a computational process 105. Execution states may include “executing,” indicating that the computational process 105 is actively running; “pending,” indicating that the computational process is scheduled to be executed within a defined time window; “unscheduled,” indicating that no execution time has been assigned; and “contingent,” indicating that execution in the time window depends on the occurrence of a prerequisite event, rule, or condition.

A usage rule is a category, policy, requirement, or limitation that specifies one or more conditions, events, or thresholds for accessing or using a particular data item or a particular subset of data items of the computational dataset 113 by a computational process 105. In some cases, a usage rule may indicate that a respective data item is always used by the computational process 105. For example, where a process relies on particular reference information during execution, the usage rule may be designated as “Yes” or “Unconditional.” In such cases, if updated, the data item is always synchronized prior to execution of the computational process. In other embodiments, a usage rule may indicate that a respective data item is conditionally accessed or used by the computational process 105. For instance, the rule may specify that a data item is used during a certain calendar period (e.g., end-of-quarter financial data used exclusively during quarterly reporting runs), when a particular configuration flag is set (e.g., enabling an optional module), or when a related computational process 105 has executed successfully (e.g., consumption of updated data items generated by an upstream process). Conditional usage rules may be expressed as Boolean logic statements, rules-based policies, or metadata constraints associated with the data item. In further embodiments, usage rules may incorporate temporal or contextual conditions. For example, a usage rule may specify that a data item is to be used if updated within a defined time threshold (e.g., within the past 24 hours). Usage rules may be probabilistic, reflecting historical patterns of use by a computational process. For example, a usage rule may indicate that a data item is accessed with an 80% likelihood during execution.

The past use parameter refers to a numerical value that indicates the number of times a computational process has accessed or consumed a particular data item. In some embodiments, the count may reflect total lifetime accesses, while in other embodiments the count may be limited to a defined period (e.g., the last 30 days). The count of past uses may be incremented automatically by the system each time a process reads or otherwise accesses a data item. The past use parameter may be used to determine access frequency as well as to predict the access or use of frequently used data items.

A synchronization flag refers to an indicator that specifies whether a data item has been synchronized, requires synchronization, or may bypass synchronization. In some embodiments, the synchronization flag is a Boolean value (e.g., 0 or 1) that indicates if a data value should be synchronized or not synchronized in a next partial synchronization process. In other embodiments, a synchronization flag may have values such as “synchronized,” “pending synchronization,” or “excluded.”

In one or more embodiments, a machine learning (ML) algorithm 134 is an algorithm that can be iterated to train a target model f that best maps a set of input variables to an output variable. In particular, an ML algorithm 134 is configured to generate and/or train a synchronization model 136. An ML algorithm is an algorithm that can be iterated to train a target model f that best maps a set of input variables to an output variable using a set of training data. The training data includes datasets and associated labels. The datasets are associated with input variables for the target model f. The associated labels are associated with the output variable of the target model f. The training data may be updated based on, for example, feedback on the predictions by the target model f and accuracy of the current target model f. Updated training data is fed back into the ML algorithm that, in turn, updates the target model f.

An ML algorithm 134 generates a target model f such that the target model f best fits the datasets of training data to the labels of the training data. Additionally, or alternatively, an ML algorithm 134 generates a target model f such that when the target model f is applied to the datasets of the training data, a maximum number of results determined by the target model f matches the labels of the training data. Different target models may be generated based on different ML algorithms and/or different sets of training data.

An ML algorithm 134 may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

The synchronization model 136 is an ML model trained using the ML algorithms 134 to make predictions, recognize patterns, or perform tasks without being explicitly programmed for specific decisions. The synchronization model 136 is trained to predict if a target computational process will execute in a given time window. For example, a set of inputs may include information describing a target computational process, such as prior execution schedules, start and end times of execution, dependency information, and workflow information. Based on the combination of input data for a target computational process 105, the synchronization model 136 predicts if the target computational process 105 is planned to execute in a current time window.

In an embodiment, a set of training data 138 for training a supervised ML model includes historical execution information of reference computational process. Such data may include feature data representations prior execution schedules, start and end times of computational processes, dependency information, and workflow information of the reference computational processes. For example, the training dataset may include information identifying related tasks as well as dependency graphs linking computational processes to prerequisite events. The training dataset further associates the collected features with a label that defines if the computational process executed within a time window. In other embodiments, the label may represent a categorical value, such as the particular time window (e.g., “executed within 0-30 minutes,” “executed within 30-60 minutes,” “executed after 60 minutes”). In still other embodiments, the label may represent a probability or confidence score indicating the likelihood that the process executed within the specified time window.

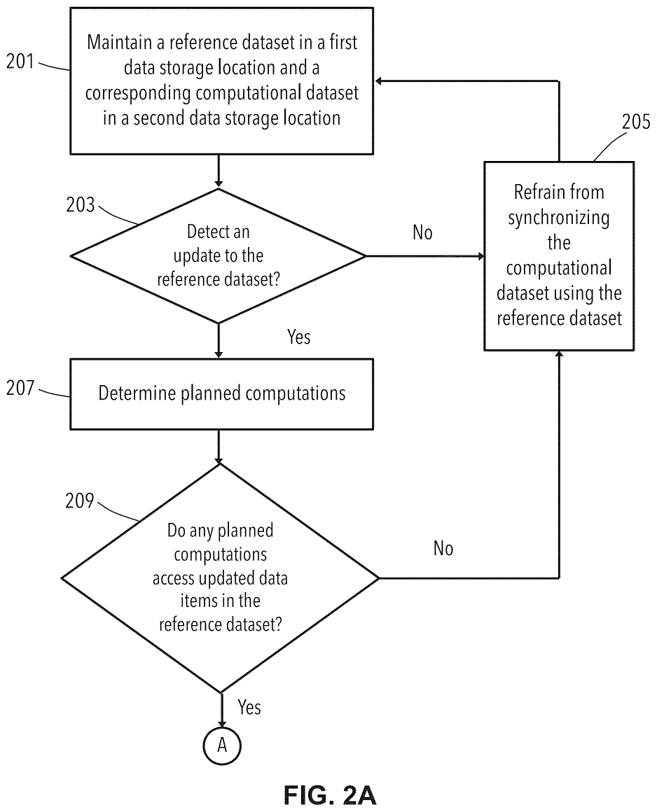

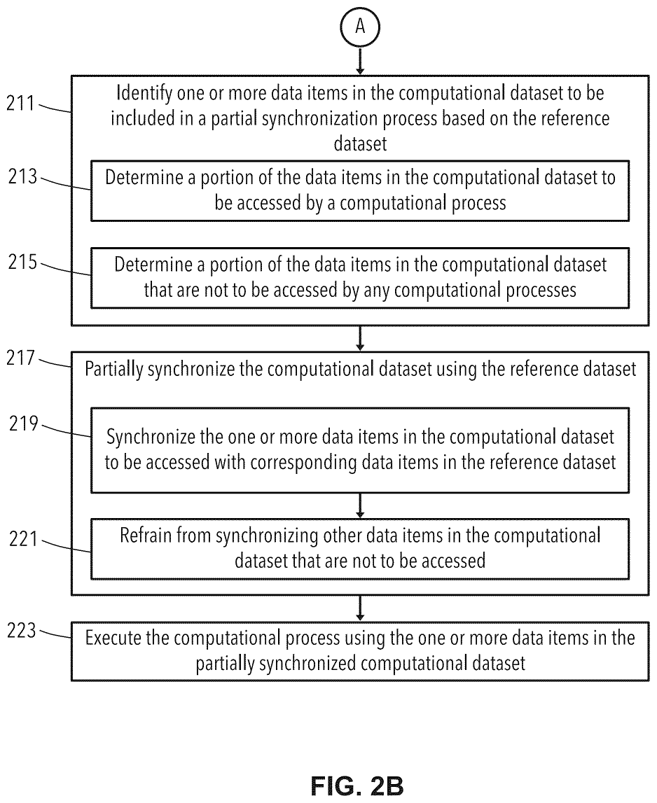

In one or more embodiments, the computing device 122 includes hardware and/or software configured to perform operations described herein. Example operations are described below with reference to FIGS. 2A and 2B. The computing device 122 executes computer-readable program instructions, such as an operating system and application programs, that are stored in memory devices and/or the storage system. Additionally, the computing device 122 executes program instructions of the synchronization manager 103 and the computational processes 105, as described above. Additionally, the computing device 122 executes program instructions of a dataset manager 150, a process manager 152, and a machine learning engine 154.

The dataset manager 150 manages datasets, such as the reference dataset 111 and/or the computational dataset 113, including maintaining the dataset logs 130 with metadata describing updates to data items in the datasets 111 and 113, respectively. As detailed above, the metadata may include timestamps of updates, version identifiers, and flags indicating if, for example, data items have been newly added, modified, or deleted. The metadata may also include statistics of the data items, such a count of past updates, a count of past uses of the data items, and checksum values for individual data items.

The process manager 152 manages the execution of the computational processes 105 by the data management system 110 or another computing device. The process manager 152 may function to schedule, monitor, and allocate the computational processes 105 for execution. In some embodiments, managing the computational processes 105 includes determining and updating the execution states of the computational processes 105 and storing corresponding entries in the synchronization map 132. The process manager 152 may determine execution states by querying a runtime scheduler that specifies attributes of each computational process 105, such as a designated start time, an expected duration, a priority level, or dependency requirements. The runtime scheduler may also maintain a queue of computational processes 105 that indicate a scheduled time or time frames for execution. Additionally, the process manager 152 may determine execution states by evaluating a dependency graph that identifies whether a target computational process 105 is contingent on the completion of another process or on the availability of specific data items in the computational dataset 113. Furthermore, the process manager 152 may predict planned computations using an ML model trained to predict that a computational process 105 will execute within a current time window.

The ML engine 154 may execute one or more ML algorithms 134 to the synchronization model 136. For example, the ML engine 154 may retrieve attributes extracted from sets of the training data 138 and convert the attributes to feature vectors to generate computer-readable features optimized for the ML algorithms 134 and/or the synchronization model 136. Using the feature vectors, the ML engine 154 uses the ML algorithms 134 to train the synchronization model 136 to predict if a computational process 105 is planned for execution. For example, the synchronization model 136 may predict a time frame for likely execution of a target computational process 105.

The interface 124 refers to hardware and/or software that facilitates communications between a user and agents. The interface 124 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms. In an embodiment, different components of interface 124 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 124 is specified in one or more other languages, such as Java, C, or C++.

### 4. Partial Synchronization

FIGS. 2A and 2B illustrate an example process comprising a set of operations for partially synchronizing certain content between corresponding datasets in accordance with one or more embodiments. One or more operations illustrated in FIGS. 2A and 2B may be modified, rearranged, or omitted. Accordingly, the particular sequence of operations illustrated FIGS. 2A and 2B should not be construed as limiting the scope of one or more embodiments.

In an embodiment, a system maintains a reference dataset in a first data storage location and a corresponding computational dataset in a second data storage location (Operation 201). The first data storage location and the second data storage location may be included in the memory of the same storage device or in the memories of different storage devices. The storage devices may both be stored on a hardware memory component of the same type or stored on the same hardware memory component. The computational dataset may be a version, a copy, and/or a backup of data included in the reference dataset. Some embodiments of the computational dataset are a derivative or subset of the reference dataset. Maintaining the reference dataset includes updating the values of data items in the datasets and logging metadata, such as timestamps, past use counts, and past change counts. Updating the values may include receiving and replacing data or values for one or more data items in the datasets. For example, in the context of an income tax processing platform, the reference dataset may be a database record that stores tax information of an individual, such as client name, birthdate, social security number (SSN), address, filing status, income, exemptions, and deductions related to various time periods (e.g., fiscal quarters and fiscal years). The client or other user may submit updated information to the system for the record, changing the client's data. Additionally, or alternatively, the system may update the values of data times based on an external source, such as a user input device, an enterprise management system, or a data warehouse.

The system may store the updated data and metadata describing the updates. As described above, some embodiments maintain one or more data logs including metadata describing the updates, such as timestamps, version identifiers, status flags, counts of past updates, counts of past uses of the data items, and checksum values. For example, as described above, FIG. 3A illustrates a data structure 301 of a data log for a reference, and FIG. 3B illustrates a data structure 311 of a data log for a computational dataset.

The system detects if the reference dataset has been updated (Operation 203). The system may periodically check for updates to the reference dataset at fixed intervals, such as hourly or daily, to detect the reference dataset's status. For example, the system may determine that the reference dataset has been updated by checking an update flag, timestamp, or checksum of the reference dataset in a dataset log. Additionally, the system may determine if the reference dataset has been updated based on the occurrence of an event, such as queuing, planning, or scheduling a computational process, that uses the computational dataset. For example, the system may query a runtime scheduler to determine if any computational processes are scheduled and, if so, check for updates to the referenced data set. Furthermore, the system may receive notifications from external systems indicating that the reference dataset was updated. For example, a dataset manager may generate and transmit an update notification in response to the reference dataset being updated. Similarly, a database management system may expose an application programming interface (API) that the system queries or subscribes to update events.

If the system determines that reference dataset has not been updated, then the system refrains from synchronizing the computational dataset using the reference dataset (Operation 205) and iteratively returns to maintaining the datasets (Operation 201). Refraining from synchronization may include intentionally delaying synchronization. For example, they system may prevent execution of a synchronization process, such as a synchronization pipeline, to retain the current state of the computational dataset.

If the system determines that the reference dataset has been updated, then the system determines planned computations (Operation 207). As described above, planned computations include computational processes that are expected to execute tasks or operations within a current time window. One or more embodiments determine planned computations based on a fixed schedule, rule-based schedule, or a prediction. A fixed schedule computation has an assigned execution time or time window. In some embodiments, the schedule may be obtained from a runtime scheduler that maintains a job queue or calendar of computations from a fixed timetable (e.g., daily batch processing at 12:00 a.m.). A rule-based scheduled computation is conditioned on a trigger (e.g., execute at the end of each business day). Predicted computations do not yet have an assigned execution time or time window. One or more embodiments predict computations by applying an ML model, such as a synchronization model, trained on historical information relating to prior computation executions, task dependencies, data availability, or workflows. The synchronization model generates a prediction of computations, including estimated start times, and expected execution windows. Some embodiments of the synchronization model may predict that a given computation will execute within a time window even where no explicit schedule exists. For example, a model may predict with 80% confidence that a computational process will execute within the time window even though no explicit entry for the computational process currently exists in a scheduling system.

The system determines if any of the planned computations access the updated data items in the reference dataset (Operation 209). In some embodiments, determining if the planned computations access the updated the data items may be based on mappings that associate computational processes with respective data items accessed by the computational processes. The system may maintain dependency mappings in a database that links data identifiers with computational processes. For example, as described above, FIG. 3C illustrates an example synchronization map mapping an identifier of a computational process 322 (e.g., “TaxPrepA”) with data items 326.

Additionally, the system may determine the mappings using library files or configuration files associated with the computational processes. The files may declare the inputs, datasets, or schema elements required by a given process. For example, a library file associated with a tax calculation process may specify that the process requires “Adjusted Gross Income,” “Dependent Count,” and “Credit Schedule” data items. The system parses these declarations and uses them as dependency mappings to determine if updated data items are required for the process.

Furthermore, the system may determine mappings by analyzing the instructions included in the computational processes. For example, the system may parse executable code, query statements, or workflow specifications associated with a computational process to identify references to dataset identifiers. A process that includes an instruction, such as “SELECT Income, Deductions FROM TaxTable,” may be inferred to require access to the “Income” and “Deductions” fields of the dataset.

If the system determines that no planned computations access the updated data items in the reference dataset, then the system refrains from synchronizing the computational dataset using the reference dataset (Operation 205) and iteratively returns to maintaining the datasets (Operation 201), as described above. If the system determines that at least one planned computation accesses the updated data items in the reference dataset, then the system identifies one or more data items in the computational dataset to be included in a partial synchronization process based on the reference dataset (Operation 211), as indicated by off-page connector “A.”

In some embodiments, the system identifies the data items to be included in a partial synchronization process for each planned computational process based on a mapping that associates the computational processes with the data items accessed by the computational process. The mapping may be implemented as an indexed data structure, such as a relational table or key-value store, that maps each computational process identifier to a set of dataset identifiers that correspond to the data items accessed. For example, the synchronization map in the data structure 321 illustrated in FIG. 3C maps a computational process 322, “TaxPrep_A,” with a set of data items 236. In some embodiments, the mapping may associate computational processes with one or more sub-processes that are mapped to respective sets of data items. For instance, a tax preparation computation may be mapped to different sub-processes, such as income calculation, credit determination, and deduction validation, with each sub-process mapped to corresponding data items. The system may traverse the hierarchy to identify data items for the synchronization operation.

The system determines a portion of the data items in the computational dataset that are to be accessed by the planned computation process (Operations 213). Determining the portion of data items may include searching or querying the mapping associated with the computational process. The mapping may associate the individual computational processes with one or more usage rules, indicating the conditions for expected access of specific data items. For example, illustrated in FIG. 3C, the usage rules 328 indicate conditions for corresponding to the data items 326. In some embodiments, the usage rules are fixed. A fixed usage rule specifies that a data item is always required by a computational process regardless of context. For example, an income tax calculation process may always require access to current gross income data.

Additionally, a usage rule may be conditioned on time. A time-conditioned usage rule may specify that a data item is required when the current date or time satisfies a temporal condition. For example, a rule may indicate that a year-to-date sales dataset is required after 2025-01-01, or that an end-of-quarter dataset is required during the final week of a fiscal quarter. The system may compare the present time against the temporal condition in the rule and include the data item in the accessed portion if the condition is satisfied.

Furthermore, a usage rule may be conditioned on an event. An event-conditioned usage rule specifies that a data item is accessed based on the occurrence of an event, such as the completion of another computational process, the arrival of new data in a monitored storage location, or the issuance of an external synchronization request. For example, a downstream process generating consolidated metrics may require updated data items if an upstream ingestion process has completed. The system may monitor event signals, process logs, or dependency metadata to determine if the event condition has been met, and, if so, include the data item in the portion to be accessed.

Additionally, or alternatively, the system determines a portion of the data items in the computational dataset that are not to be accessed by any computation processes (Operation 215). The system may determine the data items to be excluded based on the usage rules, as described above. For example, the system may identify one or more data items that fail to satisfy respective usage rules. Furthermore, the system may also determine the non-accessed portion by applying rules or statistical inference derived from the log. For example, if the synchronization shows that a given data item has never been accessed by the computation process across numerous historical executions, the system may treat that item as belonging to the non-accessed portion.

The system partially synchronizes the computational dataset using the reference dataset without synchronizing or updating the one or more data items of the computational dataset identified for exclusion from the synchronization, if any (Operation 217). Partially synchronizing the datasets can include synchronizing the one or more data items in the computational dataset to be accessed by the computational process using corresponding data items in the reference dataset (Operation 219). The partial synchronization includes selectively replacing data items in the computational dataset using the updated data items in the reference dataset. For example, referring to FIG. 3C, the data items 326 “Name” and “Filing Status” of the conditional dataset would be updated based on their synchronization flag 330 of “1,” and the data item “SSN” would not be updated based on its synchronization flag 330 of “0.” Additionally, the data items “Address” and “Dependents” would be conditionally updated based on the evaluation of their respective synchronization rules 328. For instance, if the current date was after 2025-01-01, then the “Address” data item would not be updated based on the corresponding rule 328 setting a synchronization flag 330 of “0.” Additionally, the partial synchronization includes refraining from synchronizing the other data items in the computational dataset not to be accessed by any of the computational processes (Operation 221). Refraining from synchronization the data items may include intentionally preventing updates to the computational dataset to retain the current state of the data items that are not to be accessed by any computational process.

The system executes the computational process using the selectively updated computational dataset (Operation 223). The system can determine the state of the process using task management software, as described above. Upon completion of the computational process, the system may log the status of the computational process as completed. The process may then return to detecting updates to the reference set (Operation 203) and recursively determine planned computations that access updated data items over successive time windows.

### 5. Example Partial Synchronization

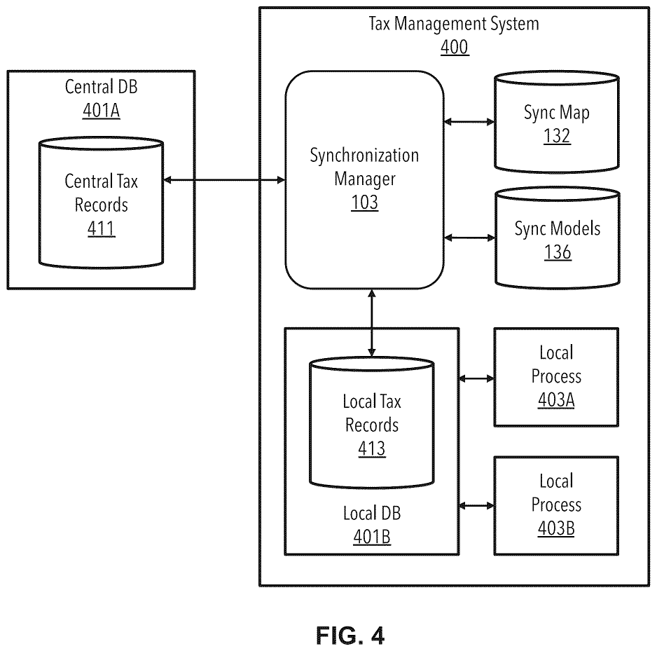

FIG. 4 illustrates a system block diagram showing an example embodiment of partial synchronization for a tax management system 400 in accordance with one or more embodiments. In the present example, the tax management system 400 at one location includes a synchronization manager 103 that controls synchronization of tax information recorded in a local database 401B with tax information at a central database 401A. The central database 401A stores current information of central tax records 411, whereas the local database 401B stores local tax records 413 that copies at least a subset of the central tax records 411 associated with that location. Based on updates to tax information recorded in the central tax records 411, the central tax records 411 include data items having values or attributes that differ from data items stored in the local tax records 413.

The tax management system 401 schedules and executes local processes 403A and 403B to perform computations that access the local tax records 413. The tax management system 401 uses the local processes 403A and 403B at different times and for different purposes. For example, the local process 403A may access the local tax records 413 to compute current quarterly tax liabilities for taxpayers using a first subset of the records, such as taxable income, deductions, and credits. The local process 403B may access the local tax records 413 to determine future tax obligations for the next fiscal year using a second subset of the records, such as deferred income, depreciation schedules, and anticipated deductions. Because the local processes 403A and 403B address different purposes and time periods, the processes operate on different subsets of the local tax records 413. Changing values in the local tax records 413, such as updated income figures or newly applied credits, affects the operation of both local processes 403A and 403B. However, the local process 403A may be planned for current execution (e.g., to finalize quarterly filings), whereas the local process 403B is not scheduled to execute until the beginning of the next fiscal year. Synchronizing data items used exclusively by the local process 403B during the present quarter would unnecessarily consume resources since the data items may be updated one or more additional times prior to the execution date of process 403B.

The tax management system 401 partially synchronizes the local tax records 413 to update the data items that are to be accessed by local processes 403A and 403B when planned for execution. In the present example, the synchronization manager 103 detects if the central tax records 411 were updated with new values for at least some data items. For example, the central database 401A may be updated each evening after receiving new taxpayer filings or adjustments from a clearinghouse. The synchronization manager 103 may receive a notification message that indicates the central database 401A has been updated and/or that periodically queries the central database 401A for an update indicator.

Additionally, the synchronization manager 103 determines computations for the tax management system 400 planned within a relevant time window such as the next business day. As described above, the synchronization manager 103 may determine scheduled or predicted computations. The synchronization manager 103 may determine the scheduled computations by querying a runtime scheduler. Additionally, or alternatively, the synchronization manager 103 may predict computations by applying parameters of the computational processes, such as prior computation executions, task dependencies, data availability, or workflow information, to the synchronization model 136 trained to predict computations. In the present example, the local process 403A may be scheduled to execute nightly at 12:00 a.m. during the current tax quarter, whereas the local process 403B is not scheduled to execute until the start of the next fiscal year.

Based on determining that the local process 403A is scheduled to execute within the current 24-hour time window, the synchronization manager 103 initiates a partial synchronization process to determine if the planned local process 403A accesses updated data items in the local inventory records 413. The synchronization manager 103 may query a synchronization map 132 that maps data items used by the local process 403A against data items in the central tax records 411. For example, the synchronization manager 103 may determine that an updated income record or a revised deduction entry in the central tax records 411 is required by the local process 403A to compute current quarterly liability. In some cases, the synchronization manager 103 may determine usage based on a usage rule associated with the data item by the synchronization map 132. For instance, a rule may determine a synchronization flag of “1” (i.e., synchronize) based on different parameters, such as date, record type, or event. On the other hand, the system may determine that another data item is not used based on a usage rule. For example, a rule may include logic that determines certain deduction calculations are not needed for quarterly computations but are needed for annual computations.

Using the data items in the local tax records 413 that are to be accessed by local process 403A and excluding data items that are not to be accessed by the local process 403A, the synchronization manager 103 partially synchronizes the local tax records 413 using the updated central tax records 411. The partial synchronization includes the synchronization manager 103 selectively replacing data items relevant to the process 403 in the local tax records 413 using the updated data items in the central tax records 411. Additionally, the synchronization manager 103 refrains from synchronizing items not accessed or used in the current computations. For example, some data items, such as “Gross Income” or “Q1 Income,” would be synchronized, whereas other items, such as “Dependents,” would not be updated until required by process 403B. Additionally, conditionally updated items may be governed by synchronization rules. For instance, if the current date is prior to Jan. 1, 2025, an “Address” field may be flagged with a synchronization flag of “0” based on its rule, indicating that the field is not to be updated until the effective date of the new tax year. The tax management system 400 then executes the planned computational process 403A using the partially synchronized local inventory records 413. Upon completion, the synchronization manager 103 may monitor the central database 401A for additional updates and partial synchronizations.

### 6. Machine learning architecture

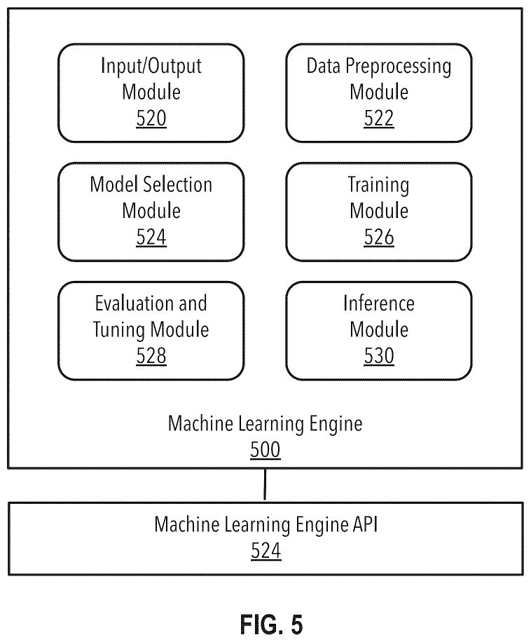

FIG. 5 illustrates a machine learning engine 500 in accordance with one or more embodiments. The machine learning engine 500 may be the same or similar to the machine learning engine previously described above. As illustrated in FIG. 5, machine learning engine 500 includes input/output module 520, data preprocessing module 522, model selection module 524, training module 526, evaluation and tuning module 528, and inference module 530.

In accordance with an embodiment, input/output module 520 serves as the primary interface for data entering and exiting the system, managing the flow and integrity of data. This module may accommodate a wide range of data sources and formats to facilitate integration and communication within the machine learning architecture.

In an embodiment, an input handler within input/output module 520 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 520 to be versatile in different operational contexts, whether processing historical datasets or streaming data.

In accordance with an embodiment, input/output module 520 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 520 includes an output framework designed to handle the distribution and exportation of outputs, predictions, or insights. Using the output framework, input/output module 520 formats these outputs into user-friendly and accessible formats, such as reports, visualizations, or data files compatible with other systems. Input/output module 520 also ensures secure and efficient transmission of these outputs to end-users or other systems in an embodiment and may employ encryption and secure data transfer protocols to maintain data confidentiality.

In accordance with an embodiment, data preprocessing module 522 transforms data into a format suitable for use by other modules in machine learning engine 500. For example, data preprocessing module 522 may transform raw data into a normalized or standardized format suitable for training machine learning models and for processing new data inputs for inference. In an embodiment, data preprocessing module 522 acts as a bridge between the raw data sources and the analytical capabilities of machine learning engine 500.

In an embodiment, data preprocessing module 522 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 522 may be configured to handle anomalies in different ways depending on context. Data preprocessing module 522 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 522 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 522 processes new data for inference, data preprocessing module 522 replicates the same preprocessing steps to ensure consistency with the training data format. This helps to avoid discrepancies between the training data format and the inference data format, thereby reducing the likelihood of inaccurate or invalid model predictions.

In an embodiment, model selection module 524 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 524 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 524 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 524 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 524 also considers computational efficiency and resource constraints. This is meant to help ensure the selected model is both accurate and practical in terms of computational and time requirements. In an embodiment, certain features of model selection module 524 are configurable such as a configured bias toward (or against) computational efficiency.

In accordance with an embodiment, training module 526 manages the ‘learning’ process of machine learning models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 526 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 526 manages overfitting, where a model learns the training data too well, including its noise and outliers, at the expense of its ability to generalize new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 526 includes logic to handle different types of data and learning tasks. For instance, it includes different training routines for supervised learning (where the training data comes with labels) and unsupervised learning (without labeled data). In the case of deep learning models, training module 526 also manages the complexities of training neural networks that include initializing network weights, choosing activation functions, and setting up neural network layers.

In an embodiment, evaluation and tuning module 528 incorporates dynamic feedback mechanisms and facilitates continuous model evolution to help ensure the system's relevance and accuracy as the data landscape changes. Evaluation and tuning module 528 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 528 performs continuous model tuning by using hyperparameter optimization. Evaluation and tuning module 528 performs an exploration of the hyperparameter space using algorithms, such as grid search, random search, or more sophisticated methods like Bayesian optimization. Evaluation and tuning module 528 uses these algorithms to iteratively adjust and refine the model's hyperparameters-settings that govern the model's learning process but are not directly learned from the data-to enhance the model's performance. This tuning process helps to balance the model's complexity with its ability to generalize and attempts to avoid the pitfalls of underfitting or overfitting.

In an embodiment, evaluation and tuning module 528 integrates data feedback and updates the model. Evaluation and tuning module 528 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 528 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 528 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 530 transforms data raw data into actionable, precise, and contextually relevant predictions. In addition to processing and applying a trained model to new data, inference module 530 may also include post-processing logic that refines the raw outputs of the model into meaningful insights.

In an embodiment, inference module 530 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 530 transforms the outputs of a trained model into definitive classifications. Inference module 530 employs the underlying model as a tool to generate probabilistic outputs for each potential class. It then engages in an interpretative process to convert these probabilities into concrete class labels.

In an embodiment, when inference module 530 receives the probabilistic outputs from the model, it analyzes these probabilities to determine how they are distributed across some or every potential class. If the highest probability is not significantly greater than the others, inference module 530 may determine that there is ambiguity or interpret this as a lack of confidence displayed by the model.

In an embodiment, inference module 530 uses thresholding techniques for applications where making a definitive decision based on the highest probability might not suffice due to the critical nature of the decision. In such cases, inference module 530 assesses if the highest probability surpasses a certain confidence threshold that is predetermined based on the specific requirements of the application. If the probabilities do not meet this threshold, inference module 530 may flag the result as uncertain or defer the decision to a human expert. Inference module 530 dynamically adjusts the decision thresholds based on the sensitivity and specificity requirements of the application, subject to calibration for balancing the trade-offs between false positives and false negatives.

In accordance with an embodiment, inference module 530 contextualizes the probability distribution against the backdrop of the specific application. This involves a comparative analysis, especially in instances where multiple classes have similar probability scores, to deduce the most plausible classification. In an embodiment, inference module 530 may incorporate additional decision-making rules or contextual information to guide this analysis, ensuring that the classification aligns with the practical and contextual nuances of the application.

In regression models, where the outputs are continuous values, inference module 530 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 530 incorporates domain-specific adjustments into its post-processing routine. This involves tailoring the model's output to align with specific industry knowledge or contextual information. For example, in financial forecasting, inference module 530 may adjust predictions based on current market trends, economic indicators, or recent significant events, ensuring that the outputs are both statistically accurate and practically relevant.

In an embodiment, inference module 530 includes logic to handle uncertainty and ambiguity in the model's predictions. In cases where inference module 530 outputs a measure of uncertainty, such as in Bayesian inference models, inference module 530 interprets these uncertainty measures by converting probabilistic distributions or confidence intervals into a format that can be easily understood and acted upon. This provides users with both a prediction and an insight into the confidence level of that prediction. In an embodiment, inference module 530 includes mechanisms for involving human oversight or integrating the instance into a feedback loop for subsequent analysis and model refinement.

In an embodiment, inference module 530 formats the final predictions for end-user consumption. Predictions are converted into visualizations, user-friendly reports, or interactive interfaces. In some systems, like recommendation engines, inference module 530 also integrates feedback mechanisms, where user responses to the predictions are used to continually refine and improve the model, creating a dynamic, self-improving system.

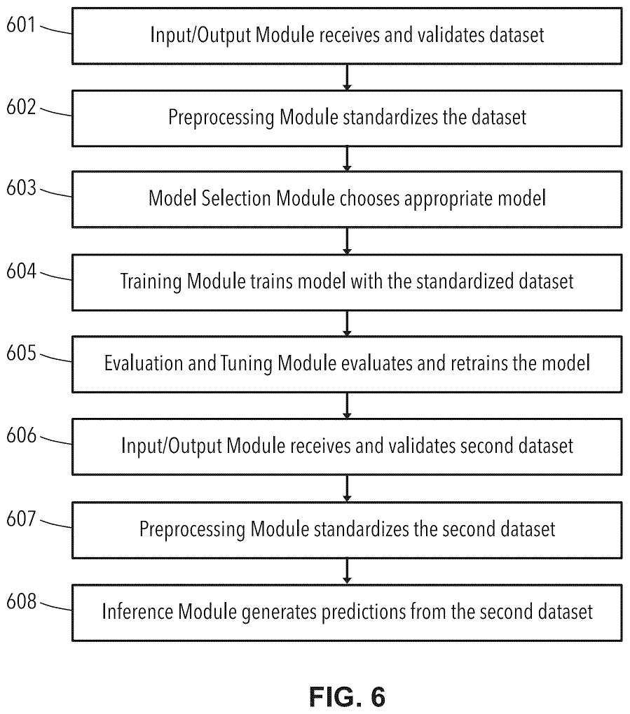

FIG. 6 illustrates an example set of operations 600 for a machine learning engine 500 in one or more embodiments. In an embodiment, input/output module 520 receives a dataset intended for training (Operation 601). This data can originate from diverse sources, like databases or real-time data streams, and in varied formats, such as CSV, JSON, or XML. Input/output module 520 assesses and validates the data, ensuring its integrity by checking for consistency, data ranges, and types.

In an embodiment, training data is passed to data preprocessing module 522. Here, the data undergoes a series of transformations to standardize and clean it, making it suitable for training machine learning models (Operation 602). This involves normalizing numerical data, encoding categorical variables, and handling missing values through techniques like imputation.

In an embodiment, prepared data from the data preprocessing module 522 is then fed into model selection module 524 (Operation 603). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 526 trains the selected model with the prepared dataset (Operation 604). It implements learning algorithms to adjust the model's internal parameters, optimizing them to identify patterns and relationships in the training data. Training module 526 also addresses the challenge of overfitting by implementing techniques, like regularization and early stopping, ensuring the model's generalizability.

In an embodiment, evaluation and tuning module 528 evaluates the trained model's performance using the validation dataset (Operation 605). Evaluation and tuning module 528 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 520 receives a dataset intended for inference. Input/output module 520 assesses and validates the data (Operation 606).

In an embodiment, data preprocessing module 522 receives the validated dataset intended for inference (Operation 607). Data preprocessing module 522 ensures that the data format used in training is replicated for the new inference data, maintaining consistency and accuracy for the model's predictions.

In an embodiment, inference module 530 processes the new dataset intended for inference, using the trained and tuned model (Operation 608). It applies the model to this data, generating raw probabilistic outputs for predictions. Inference module 530 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 540 allows for applications to leverage machine learning engine 500. In an embodiment, machine learning engine API 540 may be built on a RESTful architecture and offer stateless interactions over standard HTTP/HTTPS protocols. Machine learning engine API 540 may feature a variety of endpoints, each tailored to a specific function within machine learning engine 500. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 540 is equipped to support SOAP-based interactions. This extension involves defining a WSDL (Web Services Description Language) document that outlines the API's operations and the structure of request and response messages. In an embodiment, machine learning engine API 540 supports various data formats and communication styles. In an embodiment, machine learning engine API 540 endpoints may handle requests in JSON format or any other suitable format. For example, machine learning engine API 540 may process XML, and it may also be engineered to handle more compact and efficient data formats, such as Protocol Buffers or Avro, for use in bandwidth-limited scenarios.

In an embodiment, machine learning engine API 540 is designed to integrate WebSocket technology for applications necessitating real-time data processing and immediate feedback. This integration enables a continuous, bi-directional communication channel for a dynamic and interactive data exchange between the application and machine learning engine 500.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

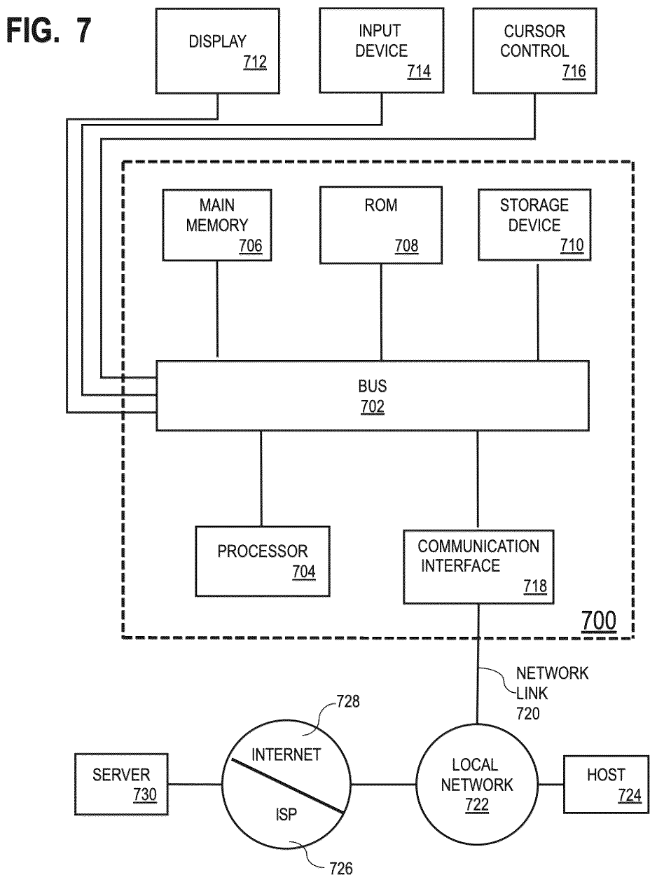

For example, FIG. 7 is a block diagram that illustrates a computer system 700 upon which an embodiment of the disclosure may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read-only memory (ROM) 708 or other static storage device coupled to bus 702 for storing static information and instructions for processor 704. A storage device 710, such as a magnetic disk, optical disk, or a Solid State Drive (SSD) is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infrared data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A non-transitory computer readable media comprising instructions that, when executed by one or more hardware processors, causes performance of a set of operations comprising:
maintaining, at a first memory location, a reference dataset, wherein:
the reference dataset corresponds to a computational dataset maintained at a second memory location, and
the computational dataset is to be updated based on updates to the reference dataset;
detecting an update to the reference dataset;
responsive to detecting the update to reference dataset:
determining that a first set of data items in the reference dataset, corresponding to a second set of one or more data items of the computational dataset to be accessed by a first computational process, have been updated with the update to the reference dataset, and
executing a partial synchronization process that partially synchronizes the computational dataset based on the reference dataset, wherein the partial synchronization process updates the second set of one or more data items of the computational dataset based on the first set of data items in the reference dataset, wherein:
executing the first computational process using the second set of one or more data items of the computational dataset that has been partially synchronized with the reference dataset.

2. The non-transitory computer readable media of claim 1, wherein detecting the update to the reference dataset comprises:
determining if the update to the reference dataset includes identifying any updates to one or more data items that are to be accessed by execution of a planned computational process.

3. The non-transitory computer readable media of claim 1, wherein determining that a first set of data items in the reference dataset have been updated further comprises:
determining a second portion of the computational dataset that are not to be accessed by the first computational process when executed.

4. The non-transitory computer readable media of claim 1, wherein the partial synchronization process is executed prior to scheduling execution of the first computational process.

5. The non-transitory computer readable media of claim 1, wherein the partial synchronization process is executed after scheduling execution of the first computational process.

6. The non-transitory computer readable media of claim 1, wherein the reference dataset and the computational dataset are both stored on (a) hardware memory components of a same type or (b) a same hardware memory component.

7. The non-transitory computer readable media of claim 1, wherein responsive to detecting the update to the reference dataset, the operations further comprise:
determining that a second set of data items in the reference dataset, corresponding to a third set of one or more data items of the computational dataset to be accessed by a second computational process, have been updated with the update to the reference dataset, and
executing the partial synchronization process that partially synchronizes the computational dataset based on the reference dataset, wherein the partial synchronization process updates the third set of one or more data items of the computational dataset based on the second set of data items in the reference dataset, wherein:
executing the second computational process using the third set of one or more data items of the computational dataset that has been partially synchronized with the reference dataset.

8. A system comprising:
at least one device including a hardware processor;
the system being configured to perform operations comprising:
maintaining, at a first memory location, a reference dataset, wherein:
the reference dataset corresponds to a computational dataset maintained at a second memory location, and
the computational dataset is to be updated based on updates to the reference dataset;
detecting an update to the reference dataset;
responsive to detecting the update to reference dataset:
determining that a first set of data items in the reference dataset, corresponding to a second set of one or more data items of the computational dataset to be accessed by a first computational process, have been updated with the update to the reference dataset, and
executing a partial synchronization process that partially synchronizes the computational dataset based on the reference dataset, wherein the partial synchronization process updates the second set of one or more data items of the computational dataset based on the first set of data items in the reference dataset, wherein:
executing the first computational process using the second set of one or more data items of the computational dataset that has been partially synchronized with the reference dataset.

9. The system of claim 8, wherein detecting the update to the reference dataset comprises:
determining if the update to the reference dataset includes identifying any updates to one or more data items that are to be accessed by execution of a planned computational process.

10. The system of claim 8, wherein determining that a first set of data items in the reference dataset have been updated further comprises:
determining a second portion of the computational dataset that are not to be accessed by the first computational process when executed.

11. The system of claim 8, wherein the partial synchronization process is executed prior to scheduling execution of the first computational process.

12. The system of claim 8, wherein the partial synchronization process is executed after scheduling execution of the first computational process.

13. The system of claim 8, wherein the reference dataset and the computational dataset are both stored on (a) hardware memory components of a same type or (b) a same hardware memory component.

14. The system of claim 8, wherein responsive to detecting the update to the reference dataset, the operations further comprise:
determining that a second set of data items in the reference dataset, corresponding to a third set of one or more data items of the computational dataset to be accessed by a second computational process, have been updated with the update to the reference dataset, and
executing the partial synchronization process that partially synchronizes the computational dataset based on the reference dataset, wherein the partial synchronization process updates the third set of one or more data items of the computational dataset based on the second set of data items in the reference dataset, wherein:
executing the second computational process using the third set of one or more data items of the computational dataset that has been partially synchronized with the reference dataset.

15. A method comprising:
maintaining, at a first memory location, a reference dataset, wherein:
the reference dataset corresponds to a computational dataset maintained at a second memory location, and
the computational dataset is to be updated based on updates to the reference dataset;
detecting an update to the reference dataset;
responsive to detecting the update to reference dataset:
determining that a first set of data items in the reference dataset, corresponding to a second set of one or more data items of the computational dataset to be accessed by a first computational process, have been updated with the update to the reference dataset, and
executing a partial synchronization process that partially synchronizes the computational dataset based on the reference dataset, wherein the partial synchronization process updates the second set of one or more data items of the computational dataset based on the first set of data items in the reference dataset, wherein:
executing the first computational process using the second set of one or more data items of the computational dataset that has been partially synchronized with the reference dataset.

16. The method of claim 15, wherein detecting the update to the reference dataset comprises:
determining if the update to the reference dataset includes identifying any updates to one or more data items that are to be accessed by execution of a planned computational process.

17. The method of claim 15, wherein determining that a first set of data items in the reference dataset have been updated further comprises:
determining a second portion of the computational dataset that are not to be accessed by the first computational process when executed.

18. The method of claim 15, wherein the partial synchronization process is executed prior to scheduling execution of the first computational process.

19. The method of claim 15, wherein the partial synchronization process is executed after scheduling execution of the first computational process.

20. The method of claim 15, wherein the reference dataset and the computational dataset are both stored on (a) hardware memory components of a same type or (b) a same hardware memory component.
